(19) United States
(12) Patent Application Publication
(10) Pub. No.: US 2013/0315469 A1
(43) Pub. Date: Nov. 28, 2013

(54) METHOD FOR 3D INSPECTION OF AN OBJECT USING X-RAYS

(71) Applicant: SATPAL SINGH, Potomac, MD (US)

(72) Inventor: SATPAL SINGH, Potomac, MD (US)

(21) Appl. No.: 13/481,253

(22) Filed: May 25, 2012

(51) Int. Cl. G06K 9/46; G06K 9/00

(52) U.S. Cl. 382/154

(57) ABSTRACT

A x-ray system for inspection of objects, utilizing two or more views has been presented. The system allows to compute the 3D spatial coordinates of certain features or object points within the object. The method used consists of first identifying feature points on the images, back tracing the ray paths from the images to the sources of radiation used, computing the point of intersection of the rays associated with each feature point and then assigning the coordinates of the intersection to the object points.

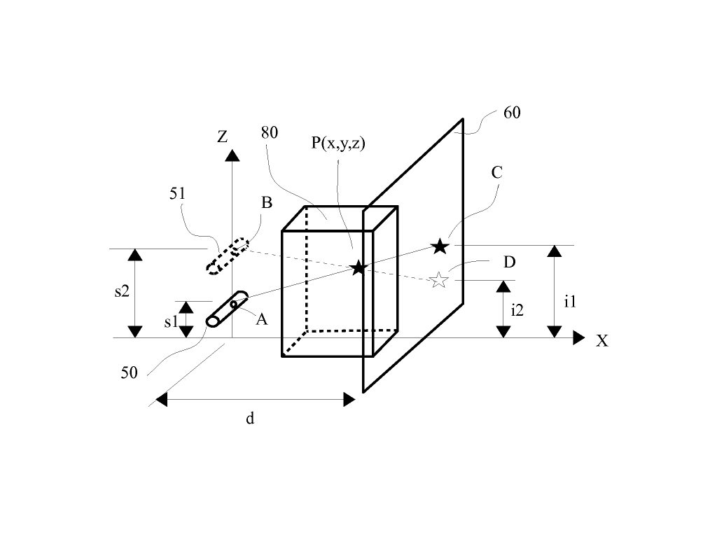

### BACKGROUND OF THE INVENTION

1. Field of the Invention

This invention describes a method of using x-rays to inspect an object or a parcel.

2. Description of the Related Art

X-ray imaging is used to view the internal composition of an object as for inspection or for medical applications. The most common form of x-ray imaging systems used are 2D that produce an image which does not contain the depth or the 3′ dimension. To overcome this problem, there are certain 3D systems like the CT or CAT systems. However, these are expensive, big and cannot be used for inspecting an object like an abandoned suitcase in the lobby of an airport, or a roadside parcel. Often, when bomb squad teams are called to inspect an abandoned package, and if they see a battery, or a wire, or a likely bomb, they want to know the precise location so that they can target for response that particular volume within the package. The existing hand held or other scanners that are in use by bomb squads do not give them the 3D coordinates of the target areas they are interested in.

The objects of this invention are therefore to overcome some of the above problems and are listed next.

### OBJECTS OF THE INVENTION

It is, accordingly, an object of the invention to present a small size x-ray scanner system for 3D inspection of objects.

It is also an object of the invention that it be used by bomb squad teams who have a need to determine the location of a bomb or a threat within the bag and also want to know its size.

These and other objects will become apparent in the description that follows.

### SUMMARY OF THE INVENTION

A novel method of inspecting an object in 3D is presented. The method involves generating two or more x-ray images by using radiation beams directed along different angles. It is not necessary to rotate the x-ray source and the detector about an object, instead just the height of the source can be changed, or the source moved closer to the object, etc. Next, a set of feature points are identified on at least two of the images. These feature points could be the corners of a box of candies inside a suitcase that could well be filled with a bomb, or could be the corners of a battery, or the terminals of a battery, or the tip of a gun, or the four corners of a polythene bag filled with some contraband.

Once the feature points are identified on an image, the rays are back traced to the source used for generating that image. Next, the same feature point is selected on the second image and a ray back traced to the source used for generating the second image. The intersection of the two rays back traced gives the 3D spatial coordinates of an object point within the object being inspected. Further, by studying the connectivity between the feature points and or the object points, one can ascertain the size of the region of interest within the object being scanned.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

The accompanying FIGURE shows a simplified sketch of the system as per one embodiment of this invention.

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

A simplified sketch of the preferred embodiment of the invention is shown in the accompanying FIGURE. A x-ray source 50 is shown situated along Y axis at a height s1, this location of the source being called the first position of the source and emits a first radiation towards a detector 60. The source 50 has a focal point A from where usually a cone beam emits and illuminates the object 80. Not shown in the drawing to avoid clutter are the collimator to shape the radiation beam, and other mechanics and electronics associated with a x-ray imaging system that are well known to a person skilled in the art.

Interposed between the detector 60 and the source 50 is placed an object 80 to be inspected. For the sake of simplicity, the detector 60 is shown as two dimensional and it displays an image resulting when the x-rays from the source 50 impinge on it after passing through the object 80. On the image is shown a feature at position C resulting due to the actual object point at point P(x,y,z) within the volume of object 80. This object point at point P(x,y,z) could be feature like the tip of a gun inside a bag, or a tip of a knife or it could be one of the four corners of a bag filled with contraband, or some other feature that stands out with respect to its immediate surroundings within the object 80.

Once the image is generated with the source at height s1, the source is moved to a new location 51 at height s2 with its focal point now denoted by B. The radiation emitted by the focal point B is being termed the second radiation and it illuminates the object 80 at a different angle compared to the first radiation. The direction of the first radiation is termed the first direction and that of the second radiation is termed the second direction. The image of the feature point P(x,y,z) due to the second radiation is now created on the detector 60 at point D. As shown in the drawing and apparent to a person skilled in the art, the height i1 of C is different from height i2 of D.

As is apparent to a person skilled in the art, the image at point C in the first image is a result of all points within the object 80 lying on a straight line connecting C to focal point A. Likewise the image at point D in the second image is due to all points lying on a straight line connecting D to B. So, if an identifiable feature or an object point like the tip of a knife or a terminal of a battery is visible on first image at C and at D on second image, then it must be located within the object 80 at the intersection of lines AC and BD. It should be noted that connecting lines from C to A or from D to B is in essence back tracing or back projecting the x-rays from image points to their respective sources of radiation.

The method of this invention thus comprises of first identifying feature points in an image or a view obtained using a first radiation directed along a first direction. Next the same feature points are also identified on a second image or second view obtained by using a second radiation that has a different orientation or direction compared to the first radiation. From each feature point in the first image a ray is back traced to the source A, the line connecting the feature point on first image to the first source 50 with a focal point A is called the first line associated with the feature point. Likewise the back traced ray along line BD is termed the second line associated with the feature point. The intersection of lines AC and BD yields the location of an object point P(x,y,z) within the object.

If more than one feature points are identified, then the connectivity of these feature points on the first and second images as well as the connectivity of the computed object points will indicate a contiguous structure or a region within the object volume such as a plastic bag filled with some contraband. The spatial coordinates of these feature points along with those of computed object points would then define the spatial extent of the contraband bag. It should be noted that to determine contiguous regions with said object, it is not necessary to consider all the feature points and all the object points but only some of them could be used.

In the above embodiment, the height of the x-ray source 50 has been changed, but instead the source could have been shifted horizontally in a direction perpendicular to the plane of the paper so that the height s1 could have remain unchanged. For such a lateral or horizontal shift of the source, the detector would have to be rotated through suitable angle to remain oriented towards the source.

In another embodiment, the x-ray source could have also been simply moved back or closer to the object 80 to obtain a second image. Instead of moving the source, the object could be displaced or rotated relative to the source, or the combination of source and detector rotated about the object.

It should be noted that the second radiation along a second direction can be obtained by simply moving just the source or just the detector relative to the object to obtain a second radiation along a second direction. That is by moving at least one of source or the detector relative to the object, one can obtain a second radiation along a second direction.

In the embodiment described, the detector has been shown to be a two dimensional one, but instead the image could be obtained by using a linear detector that is moved relative to the object to generate a scanned image.

As will be apparent to a person skilled in the art, there are number of ways the direction of the radiation through the object can be changed to generated different views of the object. The important aspect of the invention is to take two or more views of the object using radiations directed along different directions, identifying features on the views or images and back tracing or back projecting the ray paths from the images to the source and computing the points of intersection of the back projected rays to ascertain the spatial coordinates of the feature points within the volume of the object being scanned or inspected.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A method of inspecting an object in 3D comprising the steps of:
generating a first radiation using a radiation source, said first radiation directed along a first direction;
placing a radiation detector at a suitable distance from said radiation source;
interposing said object to be inspected between said radiation source and said detector;
using said detector to detect said first radiation after it has passed through said object;
using a means to generate a first image from signals detected by said detector;
generating a second radiation along a second direction such that said second radiation passes through said object;
detecting said second radiation after it has passed through said object;
generating a second image from signals obtained by said detecting of said second radiation;
identifying a set of at least one feature point such that each said feature point is visible on both said first and said second images;
associating to each said feature point a first line connecting said feature point on said first image to source of said first radiation;
associating to each said feature point a second line connecting said feature point on said second image to source of said second radiation; and
associating to each said feature point an object point within the volume of an object such that spatial coordinates of said object point are the same as those for the point of intersection between said associated first line and said associated second line.

2. The method of claim 1 further comprising a step of analyzing the connectivity between at least some of said feature points or between some of said object points to define one or more regions within said object being inspected.

3. The method of claim 1 wherein at least one of said radiation source and said detector is moved relative to said object to generate said second radiation along said second direction.

4. The method of claim 2 wherein at least one of said radiation source and said detector is moved relative to said object to generate said second radiation along said second direction.

5. An apparatus for inspecting an object in 3D comprising the steps of:
a radiation source generating a first radiation, said first radiation directed along a first direction;
a radiation detector at a suitable distance from said radiation source;
a means of interposing said object to be inspected between said radiation source and said detector;
a means to generate a first image from signals detected by said detector after said first radiation has traversed through said object;
a means to generate a second radiation along a second direction such that said second radiation passes through said object;
a means to detect said second radiation after it has passed through said object;
a means to generate a second image from signals obtained by said means to detect said second radiation;
a means to identify a set of at least one feature point such that each said feature point is visible on both said first and said second images;
a computing means to associate to each said feature point a first line connecting said feature point on said first image to source of said first radiation;
a computing means to associate to each said feature point a second line connecting said feature point on said second image to source of said second radiation; and
a means to associate to each said feature point an object point within the volume of an object such that spatial coordinates of said object point are the same as those for the point of intersection between said associated first line and said associated second line.

6. The apparatus of claim 5 further comprising a means to analyze the connectivity between between at least some of said feature points or between some of said object points to define one or more regions within said object being inspected.

7. The apparatus of claim 5 further comprising a means to move at least one of said radiation source and said detector relative to said object to generate said second radiation along said second direction.

8. The apparatus of claim 6 further comprising a means to move at least one of said radiation source and said detector relative to said object to generate said second radiation along said second direction.
